(19) United States
(12) Patent Application Publication
(10) Pub. No.: US 2005/0038920 A1
(43) Pub. Date: Feb. 17, 2005

(54) Keyboard controller

(76) Inventors: Hsin-Chang Wu, Jhubei City (TW); Su-Wu Lo, YongKang City (TW)

Correspondence Address: BIRCH STEWART KOLASCH & BIRCH, PO BOX 747, FALLS CHURCH, VA, 22040-0747, US

(21) Appl. No.: 10/821,968

(22) Filed: Apr. 12, 2004

(30) Foreign Application Priority Data
Aug. 12, 2003 (TW) 092122172

(51) Int. Cl. G06F 3/00

(52) U.S. Cl. 710/1

(57) ABSTRACT

A keyboard controller can parse all the data and commands. Further, the parsed commands and data are processed to hardware or firmware/micro-controller. This, therefore, can reduce the complexity of the firmware of keyboard controller. By using the keyboard controller, the provided keyboard controller can enhance flexibility and efficiency for command and data processes. More, the complexity of the required firmware is reduced.

### BACKGROUND OF THE INVENTION

1. Field of the Invention

The present invention relates to a keyboard controller. More precisely, the keyboard controller can parse all the received keyboard controller commands/data before they are processed. After parsed, the received commands/data will be sent to the pure hardware processing unit or the firmware/micro-controller unit. This mechanism, therefore, can reduce the complexity of the firmware and the loading of the micro-controller. It also can improve the processing capability and flexibility of the keyboard controller.

2. Description of the Prior Art

Conventionally, a keyboard controller is usually implemented by a micro-controller which with the firmware embedded. In other words, all the data and commands received need to be processed by the firmware which embedded in the micro-controller. Therefore, the complexity and code size of the firmware was increased in order to process all the possible types of commands/data.

Another conventional keyboard controller was implemented with the pure hardware circuitry. In other words, all the commands/data received were processed by the pure hardware unit, that means, no firmware was needed. Since this keyboard controller does not require the firmware/micro-controller unit to process commands or data, it enhances the processing efficiency. However, this kind of keyboard controller is less flexible when processing the commands/data According to the above description, the present invention is to overcome the mentioned problems. The present invention is to provide a keyboard controller. More precisely, it is a keyboard controller with a command parsing circuit circuitry After commands/data are parsed, it would be sent to the pure hardware circuitry or the firmware/micro-controller unit. As a result, the commands and data can be efficiently processed without the help of firmware. Furthermore, the flexibility was also reserved since the present of the firmware/micro-controller unit.

### 3. SUMMARY OF THE INVENTION

The object of the present invention is to provide a keyboard controller for enhancing processing capability and flexibility. Furthermore, the present invention reduces the complexity of the firmware needed for a keyboard. While the commands of the keyboard controller are sent from the host via 64h and 60h of input/output ports, the data will be parsed first, and then are sent to the pure hardware circuitry or a micro-controller for reducing the complexity of the firmware needed.

Another object of the present invention is to provide a keyboard controller, which can reduce the loading of the micro-controller. The micro-controller only needs to process the extended commands or those standard commands which needs extra operation. As a result, only those commands/data which really need to be processed by firmware are sent to the firmware/micro-controller unit, so the loading of the micro-controller is reduced since most of the commands/data are processed by the pure hardware circuitry. Further, it improves processing capability and enhances processing flexibility.

### 4. BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a simplified embodiment according to the present invention.

### 5. DETAILED DESCRIPTION OF THE PREFERRED EMBODIMENTS

The present invention relates to a keyboard controller. More precisely, the keyboard controller can parse all the data and commands. Further, the parsed commands and data are processed by the pure hardware unit or the firmware/micro-controller. This, therefore, can reduce the complexity of the firmware of the keyboard controller. By using the present invention, the provided keyboard controller can also enhance flexibility for processing the keyboard controller commands.

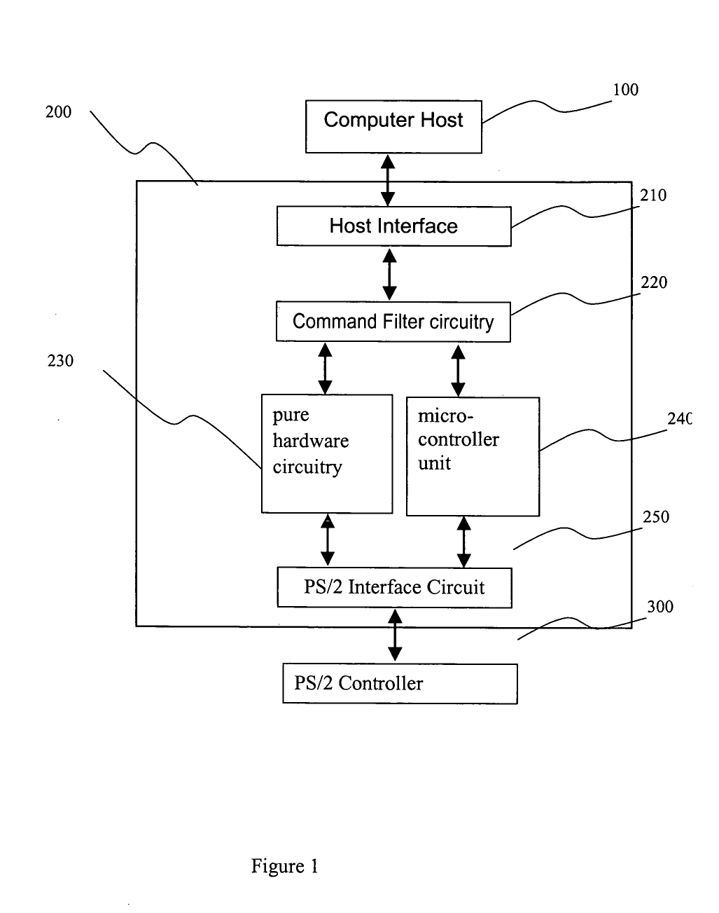

Referring to FIG. 1, it is a simplified embodiment according to present invention. The processing flow chart of the present invention can be understood as shown in FIG. 1. The keyboard controller 200 includes a computer host interface 210. The host interface can receive or send out the data or commands. A command filtering circuitry 220 is also included for parsing the received commands and data. The parsed commands/data will be sent to a pure hardware processing unit 240 or a firmware/micro-controller unit 230. A PS/2 interface circuitry 250 is included, which can send the received data and commands to PS/2 controller 300. The keyboard controller 200 can process the received commands/data by the pure hardware processing circuitry or the firmware/micro-controller unit. The received data or the commands are parsed by a command filtering circuitry, and then, sent to the pure hardware processing circuitry 230 or the micro-controller 240. The mechanism will enhance processing performance and also reserve the processing flexibility since the firmware/micro-controller still presents.

More, the provided keyboard controller 200 in present invention can reduce the loading of the micro-controller 240. In other words, the micro-controller 240 only needs to process extended commands or standard commands which need extra-operation. The received commands/data will be parsed first before they are processed. Only those commands/data which need to be processed by the micro-controller will be sent the firmware/micro-controller unit. This, therefore, reduces the loading of the micro-controller.

In addition, the command filtering circuitry 220 contains multiple controlled switches. Each switch can be used for determining where the corresponding command is sent to, either a pure hardware circuit or a micro-controller which with firmware embedded. For the further description in the command filter circuit 220, the command filter circuit 220 can parse the received keyboard controller commands/data. While the commands/data are standard, the commands/data would be sent to the pure hardware circuitry 230. By contrast, if the commands/data are not standard, the commands/data would be sent to the micro-controller unit 240.

In addition, the command filtering circuitry 200 parses the multiple data or commands. Each kind of data or commands has its corresponding controlled switch. The referenced data and commands of the command filtering circuitry 220 corresponding to switches for determining if the command or data are sent to either a pure hardware unit or a micro-controller unit for further process. For example, an A-status data or command is at off-status as well as a zero of a logical signal, the A-status data would be sent to a pure hardware circuitry 230. Otherwise, the A-status data or commands would be sent to the micro-controller unit 240. Moreover, the processing steps of the keyboard controller 200 comprise: Receiving the signal which is processed from the PS/2 controller 300 by the data/command of the computer host 100. Then, sending the signal to the host interface 210 of the keyboard controller 200. Next, the signal would be sent to the command filtering circuitry 220. Parsing the assigned signal of the host interface 210 is also included. If the corresponding switch of the signal is at off-status, the signal would be sent to the pure hardware circuitry 230. Otherwise, the signal would be sent to the micro-controller 240. The pure hardware circuitry 230 and the micro-controller unit 240 send the signal to the PS/2 interface circuitry 250. The PS/2 interface circuitry 250 contains a communication terminal of the PS/2 controller, which can collect the data or commands. Then, it sends command/data to the PS/2 controller 300 for implement in computer. The keyboard controller 200 can comiect the command/data of the computer host 100 and the PS/2 controller 300 without using complicated programming analysis of the fimiware to implement. As a result, it can reduce the complexity of the firmware programming to alternate the traditional keyboard controller. Further, while the computer host receiving the command/data of PS/2 controller 300 to return the signal, the PS/2 controller returns the signal to the keyboard controller. When the multiple data or controlled commands of the returned signal are standard commands, the signal would be sent to the pure hardware circuitry 230. Otherwise, the signal would be sent to the micro-controller unit 240. After that, the signal would be sent to the command filtering circuitry 220 for processing analysis. Then, it sends command/data to the host interface 210. The host interface 210 received the processed command of the PS/2 controller for retunig to computer host. The keyboard controller 200 can connect the computer host and the PS/2 controller 300, and can process the signal without using firmware analysis for implement.

Accordingly, no matter the signal is data or a controlled command, it would be parsed through a command filtering circuitry. Then, the data/command would be sent to the pure hardware circuitry or a micro-controller unit. Similarly, while PS/2 interface circuitry receiving command or data, it goes through the pure hardware circuitry or the micro-controlled unit. Then, after parsing through the command filtering circuitry, it returns to the computer host.

In conclusion, the present invention meets novelty, improvement, and is applicable to the industry. It therefore meets the essential elements in patentability. There is no doubt that the present invention is legal to apply to the patent, and indeed we hope that this application can be granted as a patent.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims while which are to be accord with the broadest interpretation so as to encompass all such modifications and similar structures.

1. A keyboard controller, comprising;
a computer host interface receiving multiple signals;
a command filtering circuitry parsing the said multiple signals and then processing the signals to the pure hardware circuitry or a micro-controller unit; and
an interface circuitry processing the received signals;
wherein said keyboard controller can parse multiple signals. Then, it processes the received signals to the said pure hardware circuitry or to the said micro-controller unit for achieving flexibility and extension ability.

2. The keyboard controller according to claim 1, wherein the multiple signals of the said keyboard controller can be multiple data or commands.

3. The keyboard controller according to claim 1, wherein the interface circuitry of the said keyboard controller can be 64h or 60h of input/output ports.

4. The keyboard controller according to claim 1, wherein the command filtering circuitry of the said keyboard controller can have multiple controlled switches. It uses different switches to process signal analysis and parsing works.

5. The keyboard controller according to claim 1, wherein the micro-controller unit of the said keyboard controller can be a firmware.

6. A method for controlling a keyboard controller comprising the steps of:
receiving the signals of the assigned PS/2 controller from the computer host to the host interface of the said keyboard controller. Then, transferring the signals to the command filtering circuitry;
parsing the signals of the host interface. If the signal is a standard command, the signal would be sent to the pure hardware circuitry. Otherwise, the signal would be sent to the micro-controller unit;
sending the processed signals to the interface circuitry after processing the signal by the pure hardware circuitry and the micro-controller unit; and
sending the signal to the PS/2 controller according to the command of the computer host by the said interface circuitry. The said keyboard controller using a command filter circuit parses the signal. Then, the signal would be sent to the said pure hardware circuitry or to the said micro-controller unit for achieving a fast processing speed in between a computer host and a PS/2 controller.

7. A method for controlling a keyboard controller comprising the steps of:
returning the signal to the keyboard controller while a computer ordering a PS/2 controller to return the signal by the PS/2 controller. When the returned signal is standard command, the signal would be sent to the pure hardware computer circuitry. Otherwise, the signal would be sent to the micro-controller unit; and
sending the signal to the command filtering circuitry for processing analysis. Then, sending the signals to the host interface. The host interface receives the performed commands from the command of PS/2 controller for processing, and the keyboard controller connects with the computer host and the PS/2 controller for achieving a fast processing response.
